(19) United States
(12) Patent Application Publication
(10) Pub. No.: US 2002/0172441 A1
(43) Pub. Date: Nov. 21, 2002

(54) Rolling bearing

(75) Inventors: Mamoru Aoki, Kanagawa (JP); Hiroshi Ishiwada, Kanagawa (JP)

Correspondence Address: SUGHRUE MION, PLLC, 2100 PENNSYLVANIA AVENUE, N.W., WASHINGTON, DC, 20037, US

(73) Assignee: NSK LTD.

(21) Appl. No.: 10/097,596

(22) Filed: Mar. 15, 2002

(30) Foreign Application Priority Data
Mar. 16, 2001 (JP) P.2001-075279

(51) Int. Cl. F16C 33/32

(52) U.S. Cl. 384/492; 384/625

(57) ABSTRACT

Between an inner raceway formed in the outer peripheral surface of an inner ring and an outer raceway formed in the inner peripheral surface of an outer ring, there are interposed a plurality of rolling elements. The inner ring, outer ring and rolling elements are respectively made of high carbon chromium steel, and at least one of the inner ring and outer ring is carbonitrided so as to set the surface hardness of at least one of the inner raceway and outer raceway for HRC58 or higher.

### BACKGROUND OF THE INVENTION

The present invention relates to a rolling bearing. The rolling bearing has an inner ring, an outer ring and a plurality of rolling elements respectively interposed between an inner raceway and an outer raceway. The inner raceway is formed on the outer peripheral surface of the inner ring. The outer raceway is formed on the inner peripheral surface of the outer ring.

Conventionally, in a rolling bearing of this type, as the material of its rings, there is used, for example, SUJ2 steel which is high-carbon chromium bearing steel belonging to a second class. Specifically, the SUJ2 steel is firstly hardened at a temperature in the range of 820 to 860° C. by hardening and, after then, it is tempered at a temperature in the range of 160 to 200° C. Thereby, the SUJ2steel obtains the surface hardness HRC of 58 to 64. Also, in case where corrosion resistance is required of a bearing, as the ring material, SUS440C steel is used. Specifically, the SUS440C steel is hardened at a temperature of about 1050° C. and, after then, it is sub-zero treated and is further tempered at a temperature in the range of 150 to 200° C. Thereby, the SUSU440C steel obtains the surface hardness HRC of 57 to 62. This technology is disclosed, for example, in JP-A-7-103241.

The indentation resistance of the rings obtained by the above thermal treatment is not so important when the bearing is used in an ordinary industrial machine. However, when the bearing is used in office automation (OA) equipment such as a hard disk drive (HDD) apparatus, a video tape recorder (VTR), and a laser beam printer (LBP) scanner motor, the bearing can raise the following problems.

That is, for the rolling bearing which is used in the OA equipment such as HDD, VTR and LBP, a very severe rotation accuracy (for example, JIS5-class or higher) is required from the viewpoint of noise reduction. However, for example, in case where a great impact load is applied to a spindle motor for HDD, plastic deformation such as an indentation is caused in the rolling element rolling raceways of the bearing rings supporting the rotor of the spindle motor, which lowers the acoustic characteristic and rotation accuracy of the spindly motor.

### SUMMARY OF THE INVENTION

It is an object of the present invention to eliminate the above drawbacks found in the conventional rolling bearing. Particularly, it is an object of the invention to provide a rolling bearing which is ideal for use in OA equipment of which are required low noise characteristic and low vibration characteristic.

In attaining the above object, according to a first aspect of the invention, there is provided a rolling bearing comprising: an inner ring having an inner raceway at its outer peripheral surface; an outer ring having an outer raceway at its inner peripheral surface; and a plurality of rolling elements rollably interposed between the inner raceway and the outer raceway, wherein at least one of the inner ring and the outer ring has a surface layer that is subjected to carbonitriding so as to have a surface hardness of HRC 58 or higher.

As in the first aspect of the invention, in case where at least one of the inner raceway and outer raceway has a surface layer that is carbonitrided, plastic deformations such as indentations caused by drop impact are difficult to occur in the inner raceway and/or outer raceway when compared with the conventional rolling bearing. This makes it possible to provide a rolling bearing ideal for use in OA equipment which is required to have a low noise characteristic and a low vibration characteristic. Here, the reason why at least one of the inner raceway and outer raceway has a surface layer that is carbonitrided to thereby set the surface hardness thereof for HRC 58 or higher is that, when an impact load is applied to the carbonitrided raceway, a contact surface pressure of the raceway to the rolling elements is lowered. Namely, even in case where the surface hardnesses are equal to each other, the carbonitrided layer of the surface of the raceway, due to the nitrogen content thereof, provides a lower elastic modulus than the elastic modulus of the surface of a raceway which is not carbonitrided and, therefore, when an impact load is applied to the carbonitrided raceway, a contact surface pressure of the raceway to the rolling elements is lowered.

As described above, to enhance the impact resistance of the bearing, the inner ring and/or outer ring of the bearing may be carbonitrided. However, in case where the concentration of nitrogen mixed into the inner and outer rings by the carbonitriding treatment at a depth corresponding to 2% of the rolling element diameter exceeds 0.6% by weight, in a grinding step to be executed after the carbonitriding treatment, the surface roughnesses of the inner raceway and outer raceway increase. Therefore, when performing the carbonitriding treatment on the inner ring and/or outer ring, as in a second aspect of the invention, preferably, wherein the surface layer is defined by a depth corresponding to 2% of the diameter of the rolling elements (maximum shearing stress position) from a surface thereof and the surface layer has a nitrogen concentration in the range of 0.1 to 0.6% by weight.

Also, in case where the inner ring and/or outer ring of the bearing are carbonitrided, the elastic limit of the material (for example, SUJ2 etc.) for forming the inner and outer rings is enhanced but, on the other hand, the pressure crack load is lowered. And, in the case of the lowered pressure crack load, when pressure inserting and assembling the inner and outer rings to the shaft of a motor or to a housing (such as a hub thereof), there is a possibility that a crack can occur in the inner and outer rings. Therefore, when enforcing the carbonitriding treatment on the inner ring and/or outer ring, as in a third aspect of the invention, wherein at least one of the inner raceway and the outer raceway has a thickness at its bottom portion that is set for 20% or more of the diameter of the rolling elements.

### BRIEF DESCRIPTION OF THE DRAWINGS

FIG. 1 is a section view of an example of a spindle motor for HDD;

FIG. 2 is a section view of a rolling bearing for use in a spindle motor for HDD;

FIG. 3 is a graphical representation of the relationship between impact acceleration applied to a rolling bearing and an increase in vibration acceleration;

FIG. 4 is a graphical representation of comparison between an outer ring pressure crack load in a conventional rolling bearing and an outer ring pressure crack load in a rolling bearing according to the invention; and,

FIG. 5 is a graphical representation of the relationship between the inner raceway thickness ratios and the inner ring maximum circumferential stresses when pressure inserting a bearing.

### DESCRIPTION OF THE PREFERRED EMBODIMENTS

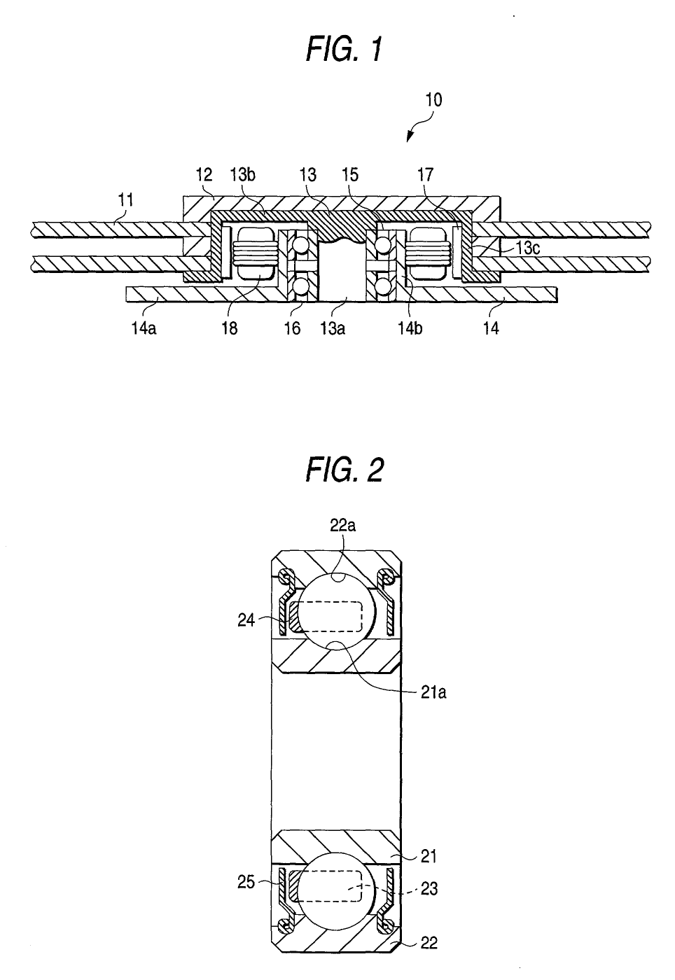

Prior to description of the preferred embodiments of a rolling bearing according to the invention, description will be given below of the structure of a spindle motor for driving a magnetic disk of an HDD apparatus with reference to FIG. 1. In FIG. 1, reference character 10 designates a spindle motor which is used to drive and rotate a magnetic disk 11. This spindle motor 10 comprises a rotary body 13 for driving the magnetic disk 11 through a hub 12, and a motor base 14 for supporting the rotary body 13 in a rotatable manner.

The rotary body 13 comprises a rotary shaft portion 13a rotatably supported on the motorbase 14 through rolling bearings 15, 16, a disk-shaped hub fixing portion 13b formed in the upper end portion (in FIG. 1) of the rotary shaft portion 13a, and a cylindrical-shaped magnet mounting portion 13c formed in the outer peripheral edge portion of the hub fixing portion 13b; and, on the inner peripheral surface of the magnet mounting portion 13c, there is mounted a rotor magnet 17.

The motor base 14 comprises a plate portion 14a to be fixed to a frame of the HDD apparatus, and a support cylinder portion 14b extended from the central portion of the plate portion 14a toward the hub 12; and, on the outer peripheral surface of the support cylinder portion 14b, there is mounted a motor stator 18 which is composed of a stator core and a stator coil.

Now, Table 1 shows the embodiments of a rolling bearing according to the invention and a comparative example.

TABLE 1

| | Inner ring | | Nitrogen | Surface |
|---|---|---|---|---|
| | and outer | Carbonitriding | concentration | Hardness |
| | ring material | Treatment | (%) | (HRC) |
| Embodiment | SUJ2 | Done | 0.1 | 62 |
| 1 | | | | |
| Embodiment | SUJ2 | Done | 0.2 | 63 |
| 2 | | | | |
| Embodiment | SUJ2 | Done | 0.4 | 63 |
| 3 | | | | |
| Comparative | SUJ2 | Not done | 0 | 62 |
| embodiment | | | | |

In Table 1, the embodiments 1 to 3 and comparative example 1 are respectively ball bearings (each having an inside diameter of 4 mm, an outside diameter of 9 mm, seven balls, and a ball diameter of 1.588 mm (1/16 inch.)) an example of which is shown in FIG. 2; and, this ball bearing corresponds to JIS (Japanese Industrial Standards) 684. That is, the ball bearing shown in FIG. 2 comprises an inner ring 21, an outer ring 22, a rolling element 23, a retainer 24, and a shield 25; and, the inner ring 21, outer ring 22, and rolling element 23 are respectively formed of SUJ2 which is high carbon chromium bearing steel. Also, the rolling element 23 is rollably interposed between an inner raceway 21a formed in the inner ring 21 and an outer raceway 22a formed in the outer ring 22, while the retainer 24 for holding the rolling element 23 is made of plastic.

Here, in the embodiment 1, the inner ring 21 and outer ring 22 are carbonitrided in such a manner that the nitrogen concentration 32 μm (2% of the rolling element diameter) under the surfaces of the inner raceway 21a and outer raceway 22b is 0.1% by weight, whereby the inner raceway 21a and outer raceway 22b can have a surface hardness of HRC62.

Also, in the embodiment 2, the inner ring 21 and outer ring 22 are carbonitrided in such a manner that the nitrogen concentration 32 μm (2% of the rolling element diameter) under the surfaces of the inner raceway 21a and outer raceway 22b is 0.2% by weight, whereby the inner raceway 21a and outer raceway 22b can have a surface hardness of HRC63.

Further, in the embodiment 3, the inner ring 21 and outer ring 22 are carbonitrided in such a manner that the nitrogen concentration 32 μm under the surfaces of the inner raceway 21a and outer raceway 22b is 0.4% by weight, whereby the inner raceway 21a and outer raceway 22b can have a surface hardness of HRC63. And, in the comparative example 1, only the normal heat treatment is enforced on the inner ring 21 and outer ring 22, whereby the inner raceway 21a and outer raceway 22b can have a surface hardness of HRC62.

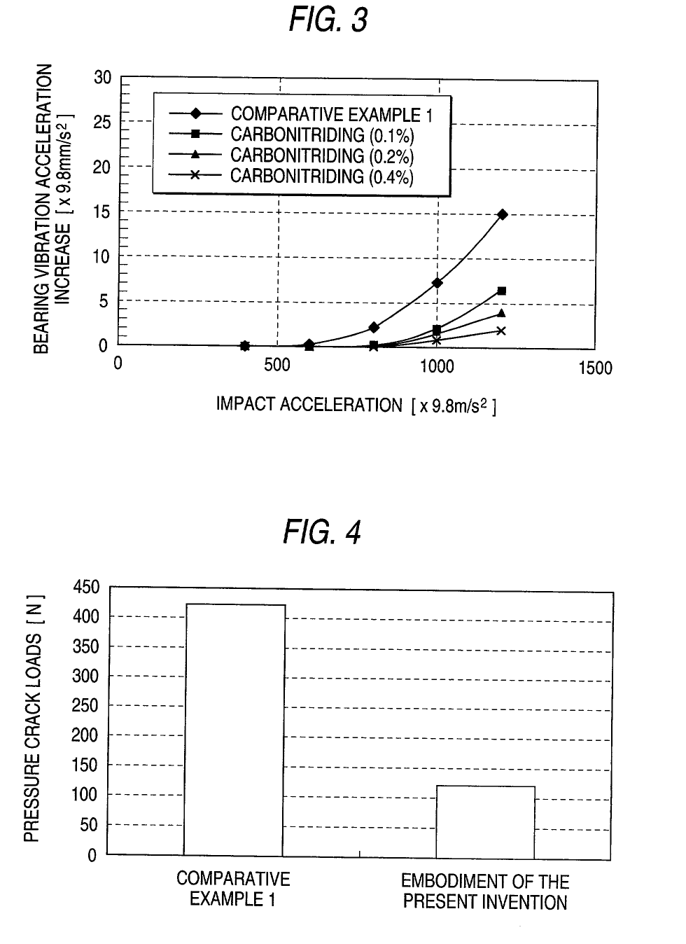

In our impact test, the ball bearings according to the embodiments 1 to 3 and comparative example 1 were assembled into the spindle motor shown in FIG. 1, and the spindle motor was dropped down from a given height, that is, impacts were given to the ball bearings within the spindle motor. And, the vibrations of the ball bearings were measured before and after application of the impacts to thereby check the degrees of the deteriorations of the ball bearings; and, FIG. 3 shows the impact test results of the ball bearings. By the way, the impact test was conducted by varying the impact load in the range from 400 to 1200×9.8 mm/s² in the motor base 14.

In FIG. 3, ♦ expresses a vibration acceleration increase when a drop impact is given to the ball bearing according to the comparative example 1, and ▪ expresses a vibration acceleration increase when a drop impact is given to the ball bearing according to the embodiment 1. Also, ▴ expresses a vibration acceleration increase when a drop impact is given to the ballbearing according to the embodiment 2, while x expresses a vibration acceleration increase when a drop impact is given to the ball bearing according to the embodiment 3.

As can be seen clearly from Fig. 3, the ballbearings according to the embodiments 1 to 3 are all better in impact resistance than the ball bearing according to the comparative example 1. Therefore, in case where one or both of the inner ring and outer ring of a bearing is or are carbonitrided whereby at least one of an inner raceway and an outer raceway has a surface hardness of HRC58 or higher, a plastic deformation such as an indentation due to the drop impact is hard to occur in the inner raceway and/or outer raceway, so that the bearing can be suitably used as a rolling bearing for supporting the rotary part of OA equipment which is required to have a low noise characteristic and a low vibration characteristic.

Also, although the test results of FIG. 3 show that the impact resistance of a bearing is enhanced as the concentration of nitrogen mixed into the bearing material due to the carbonitriding treatment increases, in case where the concentration of nitrogen mixed into the inner and outer rings through the carbonitriding treatment at a depth corresponding to 2% of the rolling element diameter exceeds 0.6% by weight, in a grinding step to be executed after the carbonitriding treatment step, the surface roughnesses of the inner raceway and outer raceway increase. Therefore, when performing the carbonitriding treatment on the inner ring and/or outer ring, from the viewpoints of the impact resistance and workability of the bearing, preferably, the carbonitriding treatment may be performed so that the nitrogen concentration of the inner raceway and/or outer raceway at a depth corresponding to 2% of the rolling element diameter is in the range of 0.1 to 0.6% by weight.

Also, as a method for fixing a bearing to the shaft of a motor or a motor base, there are available adhesion, pressure insertion and shrinkage fit. In case where the interference is large due to the pressure insertion, a large stress is applied to the ring, which, in some cases, can incur a serious damage such as a crack. However, it has been made clear that, in case where the inner and outer rings of the bearing are carbonitrided, although the elastic limit of the material (for example, SUJ2) for forming the inner and outer rings is enhanced, the pressure crack load is lowered.

Now, FIG. 4 shows the results obtained when outer ring pressure crack loads according to a conventional rolling bearing and outer ring pressure crack loads according to the invention are measured. From this figure as well, it can be seen that execution of the carbonitriding treatment on the inner and outer rings of the bearing can lower the pressure crack loads of the inner and outer rings. Therefore, when enforcing the carbonitriding treatment on the inner and outer rings of the bearing, stresses occurring when fixing the inner and outer rings to a housing must be taken into consideration.

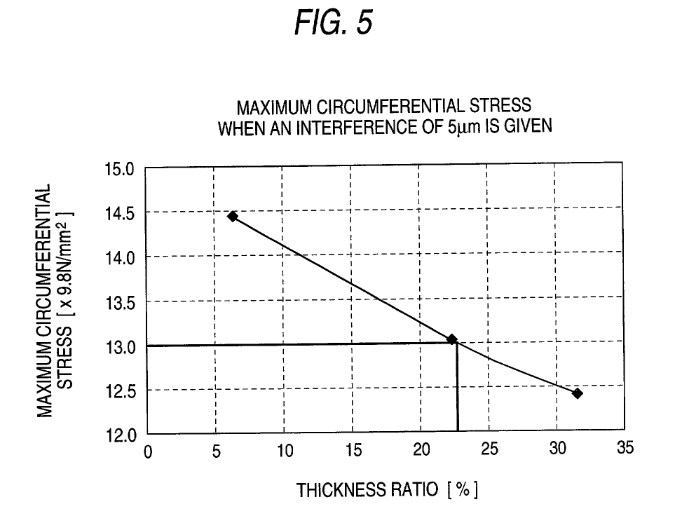

On the other hand, when pressure inserting and fixing a bearing, which is to be used in OA equipment, to a shaft or a housing, it is general to set the interference thereof on the order of 5 μm. For example, FIG. 5 shows the maximum circumferential stress values obtained when a thickness ratio between the inner ring groove bottom thickness of the bearing and the rolling element diameter thereof (that is, inner ring groove bottom thickness/rolling element diameter is varied and an interference of 5 μm is given to between the shaft and inner ring. As shown in FIG. 5, in case where a ratio of inner ring groove bottom thickness/rolling element diameter is set for 22.5%, the maximum circumferential stress value is 13.0×9.8N/mm².

Generally, when pressure inserting a bearing into a shaft or a housing, it is believed that the circumferential stresses of the inner and outer rings of the bearing may preferably be set for 127.4N/mm² (13.0×9.8N/mm²) or less. Therefore, in case where the thicknesses of the inner raceway and outer raceway with respect to the rolling element diameter are set for 20% or more, even the fixation of the bearing by pressure insertion can prevent the bearing against damage such as cracks.

By the way, in the above-mentioned respective embodiments, the inner and outer rings of the bearing are both carbonitrided. However, even in case where only one of the outer and inner ring s is carbonitrided, the impact resistance of the bearing can also be enhanced when compared with a conventional rolling bearing.

As has been described heretofore, according to the first aspect of the invention, plastic deformations such as indentations caused by drop impact are difficult to occur in the inner raceway and/or outer raceway, there can be provided a rolling bearing ideal for use in OA equipment which is required to have a low noise characteristic and a low vibration characteristic.

Also, according to the second aspect of the invention, there can be provided a rolling bearing which is ideal for use in OA equipment such as a spindle motor for HDD.

Further, according to the third aspect of the invention, in addition to the effects of the invention according to the first and second aspects of the invention, when pressure inserting and assembling a rolling bearing to a shaft or a housing, the rolling bearing can be prevented against a crack.

What is claimed is:

1. A rolling bearing comprising:
an inner ring having an inner raceway at its outer peripheral surface;
an outer ring having an outer raceway at its inner peripheral surface; and
a plurality of rolling elements rollably interposed between the inner raceway and the outer raceway,
wherein at least one of the inner ring and the outer ring has a surface layer that is subjected to carbonitriding so as to have a surface hardness of HRC 58 or higher.

2. A rolling bearing as set forth in claim 1, wherein the surface layer is defined by a depth corresponding to 2% of the diameter of the rolling elements from a surface thereof and the surface layer has a nitrogen concentration in the range of 0.1 to 0.6% by weight.

3. A rolling bearing as set forth in claim 1, wherein at least one of the inner raceway and the outer raceway has a thickness at its bottom portion that is set for 20% or more of the diameter of the rolling elements.

4. A rolling bearing as set forth in claim 2, wherein at least one of the inner raceway and the outer raceway has a thickness at its bottom portion that is set for 20% or more of the diameter of the rolling elements.

5. A spindle motor comprising:
a motor base;
a rotary body rotatably supported on the motor base, having a rotary shaft portion, a disk-shaped hub fixing portion formed in an upper end portion of the rotary shaft portion, and a cylindrical-shaped magnet mounting portion formed in an outer peripheral edge portion of the hub fixing portion;
a rotor magnet mounted on the inner peripheral surface of the magnet mounting portion;
a motor stator mounted on the motor base so as to opposed to the rotor magnet; and
rolling bearings disposed between the rotary body and the motor base and having an outer ring, an inner ring and a plurality of rolling elements between an inner raceway of the outer ring and an outer raceway of the inner ring,
wherein at least one of the inner ring and the outer ring has a surface hardness of HRC 58 or higher.

6. The spindle motor as set forth in claim 5, wherein at least one of the inner ring and the outer ring has a surface layer that is subjected to carbonitriding so as to have a surface hardness of HRC 58 or higher.
